(19) United States
(12) Patent Application Publication
(10) Pub. No.: US 2024/0323811 A1
(43) Pub. Date: Sep. 26, 2024

(54) NEIGHBOR CELL MEASUREMENT IN WIRELESS COMMUNICATION SYSTEMS

(71) Applicant: Samsung Electronics Co., Ltd., Suwon-si (KR)

(72) Inventors: Shiyang Leng, Allen, TX (US); Kyeongin Jeong, Allen, TX (US); Anil Agiwal, Allen, TX (US)

(21) Appl. No.: 18/600,543

(22) Filed: Mar. 8, 2024

Related U.S. Application Data
(60) Provisional application No. 63/453,362, filed on Mar. 20, 2023.
(60) Provisional application No. 63/454,868, filed on Mar. 27, 2023.
(60) Provisional application No. 63/457,996, filed on Apr. 7, 2023.
(60) Provisional application No. 63/464,127, filed on May 4, 2023.
(60) Provisional application No. 63/531,712, filed on Aug. 9, 2023.
(60) Provisional application No. 63/531,982, filed on Aug. 10, 2023.
(60) Provisional application No. 63/540,275, filed on Sep. 25, 2023.

(51) Int. Cl. H04W 48/10; H04L 5/00; H04W 48/20; H04W 84/06

(52) U.S. Cl. CPC H04W 48/10; H04L 5/0094; H04W 48/20; H04W 84/06

(57) ABSTRACT

Methods and apparatuses for an NTN neighbor cell measurement operation in a wireless communication system are provided. The method of UE comprises: determining whether a common search space is configured for an active bandwidth part (BWP); receiving, from a base station (BS) via a dedicated system information, a first system information block (SIB) including terrestrial network (TN) coverage information based on a determination that the common search space is not configured for the active BWP; and identifying that the TN coverage information belongs to other system information (SI).

### CROSS-REFERENCE TO RELATED APPLICATIONS AND CLAIM OF PRIORITY

The present application claims priority under 35 U.S.C. § 119(e) to: U.S. Provisional Patent Application No. 63/453,362, filed on Mar. 20, 2023; U.S. Provisional Patent Application No. 63/454,868, filed on Mar. 27, 2023; U.S. Provisional Patent Application No. 63/457,996, filed on Apr. 7, 2023; U.S. Provisional Patent Application No. 63/464,127, filed on May 4, 2023; U.S. Provisional Patent Application No. 63/531,712, filed on Aug. 9, 2023; U.S. Provisional Patent Application No. 63/531,982, filed on Aug. 10, 2023; and U.S. Provisional Patent Application No. 63/540,275, filed on Sep. 25, 2023, which are hereby incorporated by reference in their entirety.

### TECHNICAL FIELD

The present disclosure relates generally to wireless communication systems and, more specifically, the present disclosure relates to a neighbor cell measurement operation in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to an neighbor cell measurement operation in a wireless communication system.

In one embodiment, a user equipment (UE) is provided in a wireless communication system. The UE comprises a processor configured to determine whether a common search space is configured for an active bandwidth part (BWP). The UE further comprises a transceiver operably coupled to the processor, the transceiver configured to receive, from a base station (BS) via a dedicated system information, a first system information block (SIB) including terrestrial network (TN) coverage information based on a determination that the common search space is not configured for the active BWP. The processor of the UE is further configured to identify that the TN coverage information belongs to other system information (SI).

In another embodiment, a method of a UE is provided in a wireless communication system, The method comprises: determining whether a common search space is configured for an active BWP; receiving, from a BS via a dedicated system information, a first SIB including TN coverage information based on a determination that the common search space is not configured for the active BWP; and identifying that the TN coverage information belongs to Other SI.

In yet another embodiment, a BS is provided in a wireless communication system. The BS comprises a processor configured to generate a first SIB including TN coverage information. The BS further comprises a transceiver operably coupled to the processor, the transceiver configured to transmit, to a UE via a dedicated system information, the first SIB including the TN coverage information, wherein a common search space is not configured for an active BWP, and wherein the TN coverage information belongs to Other SI.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6 illustrates a flowchart of UE procedure for an enhanced HO operation using common signaling according to embodiments of the present disclosure;

FIG. 7 illustrates a flowchart of BS procedure for an enhanced HO operation using common signaling according to embodiments of the present disclosure;

FIG. 8 illustrates a flowchart of UE procedure for UE-estimated TA in mobility according to embodiments of the present disclosure; and

FIG. 9 illustrates a flowchart of UE method for an neighbor cell measurement operation according to embodiments of the present disclosure.

### DETAILED DESCRIPTION

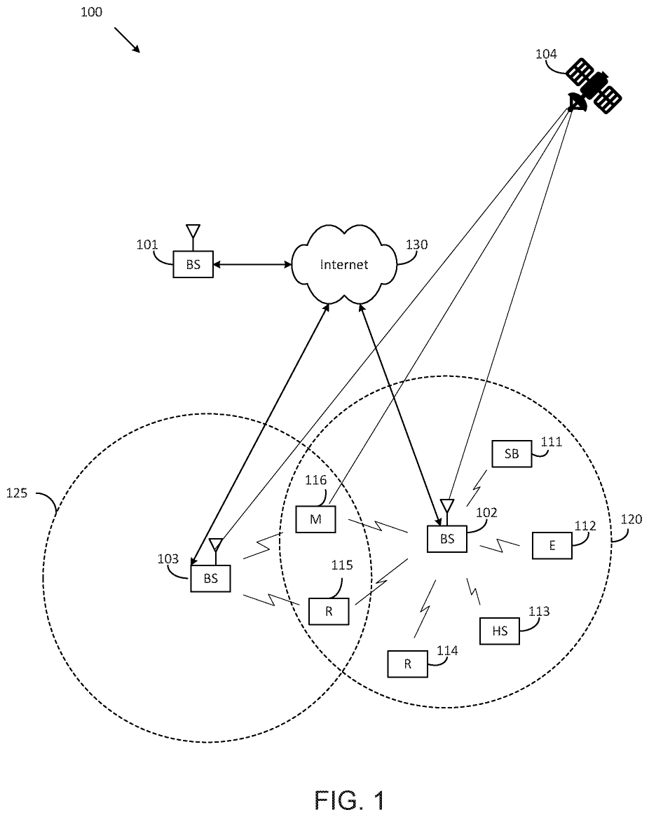

FIG. 1 through FIG. 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TR 38.811 v15.2.0, “Study on NR to support non-terrestrial networks”; 3GPP TR 38.821 v16.0.0, “Solutions for NR to support non-terrestrial networks (NTN)”; 3GPP TS 38.331 v17.5.0, “5G; NR; Radio Resource Control (RRC); Protocol specification”; 3GPP, TS 38.304 v17.5.0, “5G; NR; User Equipment (UE) procedures in idle mode and in RRC Inactive state”; and 3GPP, TS 38.300 v17.5.0, “5G; NR; NR and NG-RAN Overall description; Stage-2.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of UEs within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3GPP NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As discussed in greater detail below, the wireless network 100 may have communications facilitated via one or more communication satellite(s) 104 that may be in obit over the earth. The communication satellite(s) 104 can communicate directly with the BSs 102 and 103 to provide network access, for example, in situations where the BSs 102 and 103 are remotely located or otherwise in need of facilitation for network access connections beyond or in addition to traditional fronthaul and/or backhaul connections. Various of the UEs (e.g., as depicted by UE 116) may be capable of at least some direct communication and/or localization with the communication satellite(s) 104, for example, to receive positional information or coordinates.

An NTN refers to a network, or segment of networks using RF resources on board a communication satellite (or unmanned aircraft system platform) (e.g., communication satellite(s) 104). Considering the capabilities of providing wide coverage and reliable service, an NTN is envisioned to ensure service availability and continuity ubiquitously. For instance, an NTN can support communication services in unserved areas that cannot be covered by terrestrial networks, in underserved areas that are experiencing limited communication services, for devices and passengers on board moving platforms, and for future railway/maritime/aeronautical communications, etc.

As described in more detail below, one or more of the UEs 111-116 include circuitry, programing, or a combination thereof, for an neighbor cell measurement operation in a wireless communication system. In certain embodiments, and one or more of the gNBs 101-103 includes circuitry, programing, or a combination thereof, to support an neighbor cell measurement operation in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

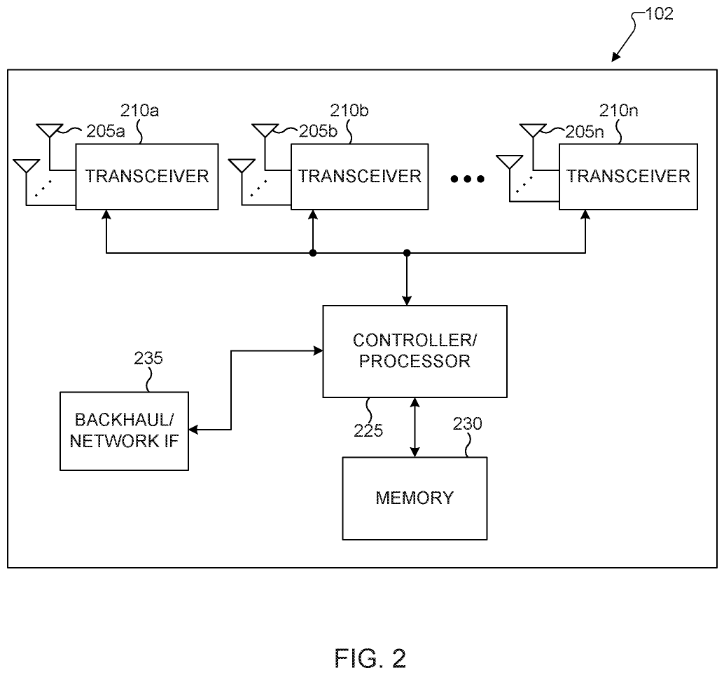

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process. The controller/processor 225 is also capable of executing programs and other processes resident in the memory 230, such as processes to support an neighbor cell measurement operation in a wireless communication system.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

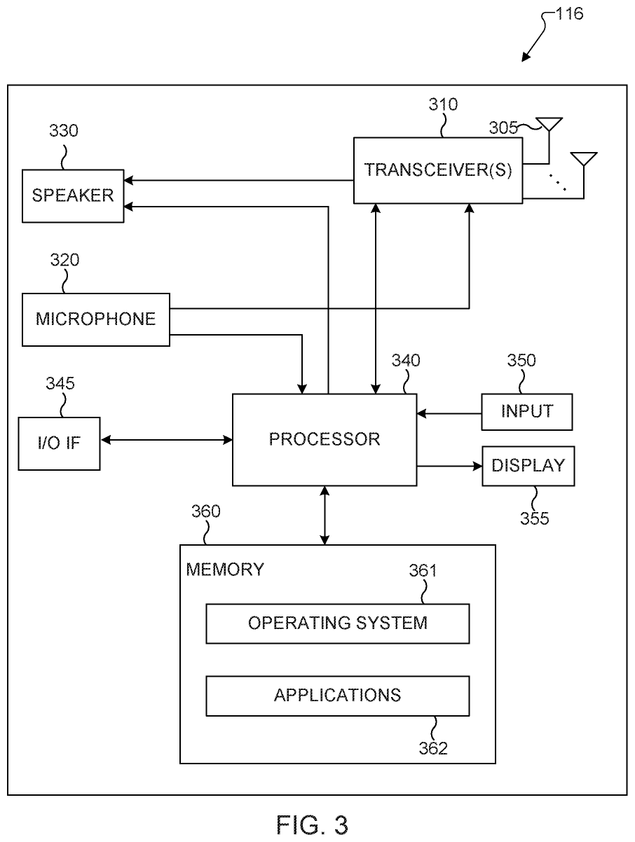

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for an neighbor cell measurement operation in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

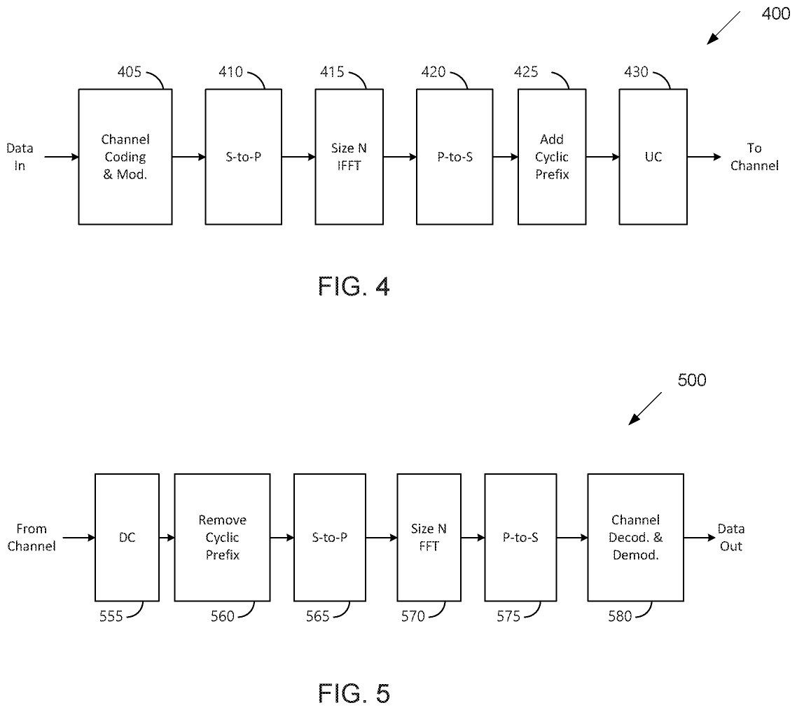

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support an neighbor cell measurement operation in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

3GPP has developed technical specifications and standards to define the new 5G radio-access technology, known as 5G new radio (NR). In Release 17 specification, an NTN is supported as a vertical functionality by 5G NR. An NTN providing non-terrestrial NR access to a UE by means of an NTN payload, e.g., a satellite, and an NTN gateway. The NTN payload transparently forwards the radio protocol received from the UE (via the service link, i.e., wireless link between the NTN payload and the UE) to the NTN Gateway (via the feeder link, i.e., wireless link between the NTN Gateway and the NTN payload) and vice-versa. Considering its capabilities of providing wide coverage and reliable service, NTN is envisioned to ensure service availability and continuity ubiquitously.

For instance, NTN can support communication services in unserved areas that cannot be covered by terrestrial networks, in underserved areas that are experiencing limited communication services, for devices and passengers on board moving platforms, and for future railway/maritime/aeronautical communications, etc. To support NTN in 5G NR, various features need to be introduced or enhanced to accommodate the nature of radio access to NTN that is different to terrestrial networks (TN) such as large cell coverage, long propagation delay, and non-static cell/satellite.

In NTN, the NTN payload can be GSO, i.e., earth-centered orbit at approximately 35786 kilometers above Earth's surface and synchronized with Earth's rotation, or NGSO, i.e., low Earth orbit (LEO) at altitude approximately between 300 km and 1500 km and medium Earth orbit (MEO) at altitude approximately between 7000 km and 25000 km. Depending on different NTN payloads, three types of service links are supported: (1) Earth-fixed: provisioned by beam(s) continuously covering the same geographical areas all the time (e.g., the case of GSO satellites); (2) Quasi-Earth-fixed: provisioned by beam(s) covering one geographic area for a limited period and a different geographic area during another period (e.g., the case of NGSO satellites generating steerable beams); and (3) Earth-moving: provisioned by beam(s) whose coverage area slides over the Earth surface (e.g., the case of NGSO satellites generating fixed or non-steerable beams).

With NGSO satellites, the BS can provide either quasi-Earth-fixed cell coverage or Earth-moving cell coverage, while BS operating with GSO satellite can provide Earth fixed cell coverage. Due to different properties of GSO and NGSO, different types of cells can be supported in NTN, which are the earth-fixed cell, the quasi-earth-fixed cell, and the earth-moving cell. For a certain type of NTN payload/cell, specific features or functionalities are desired to be supported by the UE for radio access.

For a cell selection/reselection, the UE usually measures neighbor cell to search for a suitable or acceptable cell to camp on. The BS can provide configurations on neighbor cell measurement and cell (re)-selection. The configuration can contain cell re-selection information common for intra-frequency, inter-frequency and/or inter-RAT cell re-selection, cell re-selection information per frequency (i.e., information about other NR frequencies and inter-frequency neighbor cells relevant for cell reselection), as well as cell-specific cell re-selection information for intra-frequency, inter-frequency and/or inter-RAT neighbor cells.

For the UE in a connected state (e.g., RRC_CONNECTED), the NW can provide measurement configuration for a measurement object (e.g., intra-frequency or inter-frequency neighbor cells). Based on the measurement results, the BS can prepare a handover (HO) to a target cell for the UE and trigger the HO execution by transmitting a HO command in an RRC message (e.g., RRCReconfiguration). The BS can also prepare a conditional HO (CHO) with multiple candidate cells for the UE and transmits CHO configuration in an RRC message (e.g., RRCReconfiguration) to trigger the CHO evaluation.

Due to the larger coverage area of NTN cells, the NW needs to hand over a number of UEs from the current serving cell to the same target cell in a short duration (e.g., at almost the same time especially for quasi-earth fixed scenario). In this case, sending a dedicated HO command to each UE may lead to high signaling overhead. In order to reduce signaling overhead, the NW can provide target cell common configuration to be applied for a number of UEs in common signaling, e.g., system information. The target cell common configuration can include the information element (IE) ntn-Config that contains the target cell information to be applied for HO, e.g., ephemeris, common TA parameters.

Thus, how to provide the configuration for target cells by common signaling to reduce overhead in HO and the corresponding UE behavior is desired to be specified.

On the other hand, for TN neighbor cell measurement, the BS can provide TN cell coverage information to help the UE save power in searching and measuring TN neighbor cells. Thus, the how to apply the TN coverage information in neighbor cell measurement is desired to be specified.

The present disclosure includes solutions on the procedure of applying target cell's configuration in common signaling for HO and the procedure of applying TN coverage information for neighbor cell measurements.

In the present disclosure, the assistance information for a TN neighbor measurement and/or TN cell (re)-selection includes TN geographic coverage information (e.g., reference location and/or radius for the cell coverage area) and/or TN cell type indication which indicates the cell is a TN cell.

In the present disclosure, an NTN refers to one or more of satellite, high altitude platform station (HAP) and air to ground (ATG) scenarios.

In the present disclosure, a target cell can also refer to a candidate cell.

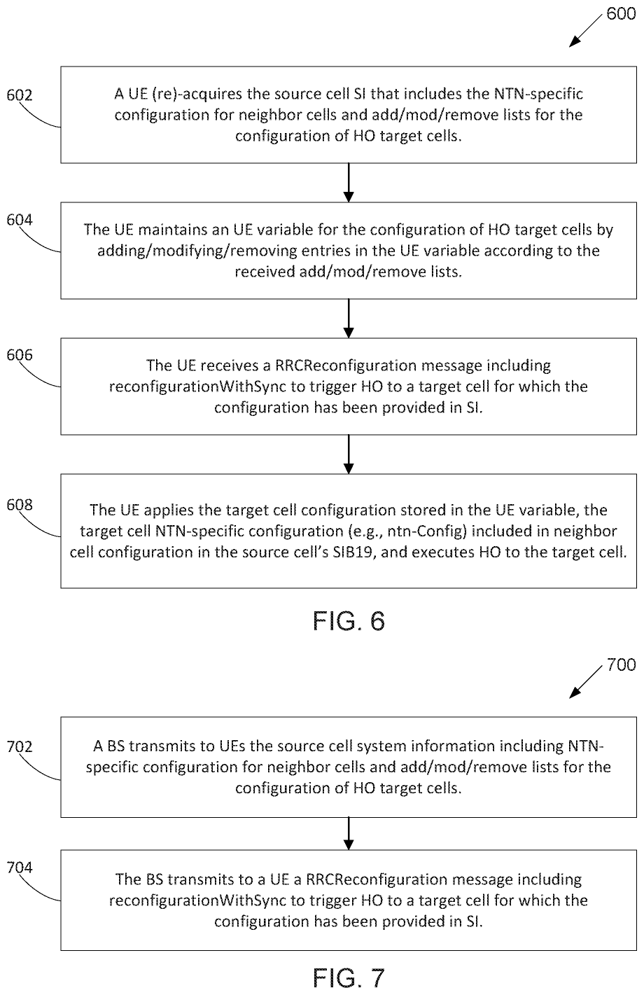

FIG. 6 illustrates a flowchart of UE procedure 600 for an enhanced HO operation using common signaling according to embodiments of the present disclosure. The UE procedure 600 as may be performed by a UE (e.g., 111-116 as illustrated in FIG. 1). An embodiment of the UE procedure 600 shown in FIG. 6 is for illustration only. One or more of the components illustrated in FIG. 6 can be implemented in specialized circuitry configured to perform the noted functions or one or more of the components can be implemented by one or more processors executing instructions to perform the noted functions.

In one embodiment, a UE procedure of enhanced HO by using common signaling is illustrates in FIG. 6. At step 602, a UE (re)-acquires the source cell SI that includes the NTN-specific configuration for neighbor cells and add/mod/remove lists for the configuration of HO target cells. At step 604, the UE maintains a UE variable for the configuration of HO target cells by adding/modifying/removing entries in the UE variable according to the received add/mod/remove lists. At step 606, the UE receives an RRCReconfiguration message including reconfigurationWithSync to trigger HO to a target cell for which the configuration has been provided in SI.

Alternatively, at step 606, the UE receives CHO configuration, starts to evaluate the CHO execution condition for candidate cells according to the CHO configuration, and selects a target cell for CHO execution. The candidate cells include the target cells for which the configuration has been provided in SI. At step 608, the UE applies the target cell configuration stored in the UE variable, and/or the target cell NTN-specific configuration (e.g., ntn-Config) included in neighbor cell configuration in the source cell's SIB19, and/or the stored conditional configuration for the selected target cell for CHO execution, and executes HO to the target cell.

FIG. 7 illustrates a flowchart of BS procedure 700 for an enhanced HO operation using common signaling according to embodiments of the present disclosure. The BS procedure 700 as may be performed by a BS (e.g., 101-103 as illustrated in FIG. 1). An embodiment of the BS procedure 700 shown in FIG. 7 is for illustration only. One or more of the components illustrated in FIG. 7 can be implemented in specialized circuitry configured to perform the noted functions or one or more of the components can be implemented by one or more processors executing instructions to perform the noted functions.

As illustrated in FIG. 7, a corresponding BS procedure of enhanced HO by using common signaling is illustrated. At step 702, A BS transmits to UEs the source cell system information including NTN-specific configuration for neighbor cells and add/mod/remove lists for the configuration of HO target cells. At step 704, the BS transmits to a UE an RRCReconfiguration message including reconfigurationWithSync to trigger HO to a target cell for which the configuration has been provided in SI. Alternatively, the BS transmits to a UE an RRCReconfiguration message including CHO configuration.

For the feature of receiving a target cell configuration by common signaling (e.g., system information), the UE can be mandatory to support the feature. Alternatively, the UE can be conditionally mandatory to support the feature. In this case, the UE is mandatory to support the feature if the UE supports NTN. In another example, the UE can be optional to support the feature. In this case, the UE sends a one-bit of UE capability indication of “support” to the BS if the feature is supported.

To provide configurations for one or more target cells by common signaling, in one embodiment of steps 602 and 702, the BS can provide the configuration for target cell(s) by add/mod/remove lists. For example, in system information (SI), e.g., SIB19, the BS can include a list of target cells to be added/modified, where each entry of the list includes a target cell's PCI and/or logical ID and/or the target cell configuration for HO (e.g., IE servingCellConfigCommon, t304 values, IE ntn-Config). The BS can include a list of target cells to be removed, where each entry of the list includes a target cell's PCI and/or logical ID.

In one embodiment, at step 604, if the UE supports the feature of receiving target cell configuration by common signaling, the UE can maintain a UE variable (e.g., VarHOConfigurationSI) for the target cell configuration in SI. The UE first (re)-acquires the SI (e.g., SIB19) containing target cell configuration according to the SI acquisition procedure as specified in 3GPP standard specification. If the list of target cells to be removed is included in the SI (e.g., SIB19), if the target cell's PCI and/or logical ID of an entry in the removing list matches the target cell's PCI and/or logical ID of an entry in the UE variable, the UE removes the existing entry with the matching PCI and/or logical ID from the UE variable.

The UE does not consider the message as erroneous if the removing list includes any entry with PCI and/or logical ID that is not included in the UE variable. If the list of target cell to be added/modified is included in the SI (e.g., SIB19), if the target cell's PCI and/or logical ID of an entry in the add/mod list matches the target cell's PCI and/or logical ID of an entry in the UE variable, the UE replaces the content of the existing entry in the UE variable with the content of the matching entry in the add/mod list; else (i.e., if the target cell's PCI and/or logical ID of an entry in the add/mod list does not exist in the UE variable), the UE adds this entry in the add/mod list as a new entry in the UE variable.

In one embodiment, at step 602, the UE can receive a target cell's configuration in SI, (e.g., SIB19), before receiving the HO command (e.g., IE reconfigurationWithSync) in a UE-dedicated RRC message (e.g., RRCReconfiguration) that triggers the HO execution to the target cell. For example, the target cell configuration in SI includes information that is contained in the target cell's master information block (MIB) and/or system information block (e.g., SIB1, SIB19). As an example, the target cell configuration in SI includes the IE ntn-Config that containing the information to be applied when performing HO to the target cell. In this case, the target cell's ntn-Config can be absent in the UE-dedicated HO command (e.g., IE reconfigurationWithSync) conveyed in an RRC message (e.g., RRCReconfiguration).

In another example, the target cell configuration in SI includes the PCI of the target cell, which is a neighbor cell listed in the current serving/source cell's SI (e.g., SIB19); and the IE ntn-Config for the target cell is absent in the target cell configuration in SI. In this case, for executing HO to the target cell at step 608, the UE applies the target cell's ntn-Config that is included in the neighbor cell configuration associated to the PCI in the current serving/source cell's SI (e.g., SIB19).

In yet another example, the IE ntn-Config for the target cell can be absent in the target cell configuration in SI and the target cell configuration in SI includes a logical ID to indicate the target cell's ntn-Config, wherein the logical ID refers to a neighbor cell configuration listed in the current serving/source cell's SI (e.g., SIB19); In this case, for executing HO to the target cell at step 608, the UE applies the target cell's ntn-Config that is included in the neighbor cell configuration associated to the logical ID in the current serving/source cell's SI (e.g., SIB19). As another example, the target cell's ntn-Config and/or the associated ID can be absent in the target cell configuration in SI, then the UE applies the current serving/source cell's ntn-Config in SIB19 for executing HO to the target cell at step 608.

In step 608, upon receiving an RRCReconfiguration message including reconfigurationWithSync to trigger HO to a target cell, in one example, if T304 timer value is configured in reconfigurationWithSync, the UE starts timer T304 for the target cell/SpCell with the timer value; or upon applying the conditional configuration for the selected target cell for CHO execution, if T304 timer value is configured in in reconfigurationWithSync in the conditional configuration, the UE starts T304 timer for the selected target cell/SpCell with the timer value for CHO execution; otherwise (i.e., if T304 timer value is not configured in reconfigurationWithSync in HO command or in conditional configuration) the UE starts timer T304 for the target cell/SpCell with the timer value stored in the UE variable that maintains the target cell configuration.

In another example, if the frequencyInfoDL is included in reconfigurationWithSync, the UE considers the target cell/SpCell to be one on the SSB frequency indicated by the frequencyInfoDL with a physical cell identity indicated by the physCellId in reconfigurationWithSync; elseif the frequencyInfoDL is stored in the UE variable that maintains the target cell configuration, the UE considers the target cell/SpCell to be one on the SSB frequency indicated by the frequencyInfoDL with a physical cell identity indicated by the physCellId in the UE variable that maintains the target cell configuration; else, the UE considers the target cell/SpCell to be one on the SSB frequency of the source cell/SpCell with a physical cell identity indicated by the physCellId.

Furthermore, the UE starts synchronizing operation to the DL of the target cell/SpCell; and/or apply the specified BCCH configuration defined in 3GPP standard specification for the target cell/SpCell. As an example, if the MIB of the target cell/SpCell is not stored in the UE variable that maintains the target cell configuration, the UE acquires the MIB of the target SpCell, which is scheduled as specified in TS 38.213. Furthermore, the UE resets the MAC entity of this cell group; and/or consider the SCell(s) of this cell group, if configured, that are not included in the SCellToAddModList in the RRCReconfiguration message, to be in deactivated state; and/or apply the value of the newUE-Identity as the C-RNTI for this cell group.

In another example, if spCellConfigCommon is stored in the UE variable that maintains the target cell configuration, the UE configures lower layers in accordance with the stored spCellConfigCommon; if spCellConfigCommon is included in the RRCReconfiguration message including reconfigurationWithSync, the UE configures lower layers in accordance with the received spCellConfigCommon in the RRCReconfiguration message including reconfigurationWithSync. The UE configures lower layers in accordance with any additional fields, not stored in the UE variable that maintains the target cell configuration, if included in the received RRCReconfiguration message including reconfigurationWithSync.

In yet another example, upon receiving the RRCReconfiguration message including reconfigurationWithSync, the UE can combine the stored target cell configuration received in the SI at operation 402 and the target cell configuration received in the RRCReconfiguration message including reconfigurationWithSync to obtain a complete target cell configuration, and apply the complete target cell configuration for HO execution.

To ensure the target cell configuration in SI at the UE is valid when executing HO/CHO, the BS can indicate a validity duration associated to the configuration of target cells in SI and update the information. In one embodiment, the configuration of target cells in SI follows the validity of the SI containing the configuration. The UE determines the change of the configuration based on the SI change indication as specified in 3GPP standard specification, and acquires the updated configuration according to the procedure of SI (re)-acquisition as specified in 3GPP standard specification.

In another embodiment, a UE maintains the configuration of each target in the UE variable until the end of the T304 timer configured for the first HO/CHO execution after the acquisition of the target cell configuration in SI. Upon the T304 timer stops (i.e., successful HO/CHO to the target cell) and/or the T304 timer expires (i.e., HO/CHO to the target cell failed), the UE considers the configuration of a target cell as invalid if the HO is not executed for this target cell and/or the UE removes the configuration of each target cell from the UE variable.

In yet another embodiment, an absolute time is indicated for each target cell configuration in SI. The UE considers the configuration for a target cell as valid before the indicated absolute time and as invalid after the indicated absolute time. The UE removes the entry for the target cell configuration from the UE variable after the indicated absolute time.

In yet another embodiment, upon receiving the configuration of a target cell in SI, the UE starts a validity timer for the configuration of the target/candidate cell. The validity timer duration and/or an absolute validity end time can be included in the configuration. If the validity timer duration value is configured, the UE sets the timer duration according to the configured value. If an absolute validity end time is configured, the UE sets the validity timer duration expires at the absolute validity end time. Upon receiving the HO command or upon selecting the target cell for CHO execution, the UE starts T304 timer for HO/CHO execution according to the T304 timer duration configured in the received HO command or in the stored target cell configuration or in the conditional configuration.

If the validity timer of the target cell configuration expires while T304 timer is running (i.e., when executing HO/CHO to the target cell), the UE considers the target cell configuration is invalid and/or stops T304 timer and/or stops HO/CHO execution to the target cell and/or declares radio link failure. The UE can perform RRC reestablishment procedure. Upon successful completion of HO/CHO execution (e.g., successful completion of Random Access to the target cell), the UE stops the T304 and/or stops the validity timer. If T304 expires, the UE can stop the validity timer and/or declare radio link failure. The UE can perform RRC reestablishment procedure.

Alternatively, the UE can keep the validity timer running when T304 stops or expires. The UE considers the target cell configuration associated with the validity timer invalid only upon the validity timer expires. The UE can remove the entry for the target cell configuration from the UE variable once the associated validity timer expires.

In one example, a UE may receive the HO command triggers HO execution (e.g., IE reconfigurationWithSync) in a UE-dedicated RRC message or select a CHO candidate cell as a target cell for CHO execution, but have not acquired a valid configuration for the target cell that contains the MIB and SIB1 of the target cell. In this case, the UE performs DL synchronization by receiving SSBs of the target cell and/or acquiring the MIB, and/or acquires SIB1, and/or acquires SIB19, before performing random access procedure to the target cell.

If the RRCReconfiguration message including reconfigurationWithSync does not include dedicatedSIB1-Delivery, and if the active downlink BWP, which is indicated by the firstActiveDownlinkBWP-Id for the target cell, has a common search space configured by searchSpaceSIB1, and if the UE has received the target cell configuration including servingCellConfigCommon in SI before receiving the HO command to the target cell, i.e., the RRCReconfiguration message including reconfigurationWithSync, and the UE successfully completes the HO execution to the target cell, and the UE does not need to acquire SIB1 of the target cell after HO execution.

If the RRCReconfiguration message including reconfigurationWithSync does not include dedicatedSIB1-Delivery, and if the active downlink BWP, which is indicated by the firstActiveDownlinkBWP-Id for the target cell, has a common search space configured by searchSpaceSIB1, and if the UE has not received the target cell configuration including servingCellConfigCommon in SI before receiving the HO command to the target cell, i.e., the RRCReconfiguration message including reconfigurationWithSync, and the UE successfully completes the HO execution to the target cell, the UE acquires the SIB1 of the target cell and performs the corresponding actions upon acquiring SIB1.

For a neighbor cell measurement operation in cell (re)-selection operation as specified in 3GPP standard specification, the BS can provide TN coverage information to help the UE save power in searching and measuring TN neighbor cells. In one embodiment, the UE follows the measurement rule based on the RSRP/RSRQ of the serving cell and/or neighbor cells as specified in TS 38.304.

Following the specified measurement rule, when TN coverage information is provided, the UE may measure TN cell(s) if it's within TN coverage, and the UE may not measure TN cell(s) if not within TN coverage. The reference location and coverage radius can be provided in system information (e.g., SIB2, and/or SIB3, and/or SIB4, and/or SIB19). The UE determines the distance between UE location and TN reference location, e.g., if the distance is larger than the radius, the UE is not in TN coverage, otherwise the UE is within TN coverage.

In one example, the enhanced measurement is provide as shown in TABLE 1.

TABLE 1
Enhanced measurement operation

- If the serving cell fulfils Srxlev > SIntraSearchP and Squal > SIntraSearchQ:

- If TN coverage information (e.g., referenceLocationTN, rangeTN) are
broadcasted in SI (e.g., SIB2, and/or SIB3, and/or SIB4, and/or SIB 19):

```
- If the distance between UE and the TN coverage reference location (e.g.,
  referenceLocationTN) is larger than a distance threshold (e.g., rangeTN),
  the UE may not perform intra-frequency measurements;
- Else, the UE performs intra-frequency measurements;
```

- Else, the UE may not perform intra-frequency measurements;

```
- Else, the UE may perform intra-frequency measurements.
- The UE may apply the following rules for NR inter-frequencies and inter-RAT
  frequencies which are indicated in system information and for which the UE has priority
  provided as defined in 3GPP standard specification:
```

```
- For a NR inter-frequency or inter-RAT frequency with a reselection priority
  higher than the reselection priority of the current NR frequency, the UE may
  perform measurements of higher priority NR inter-frequency or inter-RAT
  frequencies according to TS 38.133.
- For a NR inter-frequency with an equal or lower reselection priority than the
  reselection priority of the current NR frequency and for inter-RAT frequency
  with lower reselection priority than the reselection priority of the current NR
  frequency:
```

- If the serving cell fulfils Srxlev > SnonIntraSearchP and Squal >
SnonIntraSearchQ:

```
- If TN coverage information (e.g., referenceLocationTN,
  rangeTN) are broadcasted in SI (e.g., SIB2, and/or SIB3, and/or
  SIB4, and/or SIB19):
```

```
- If the distance between UE and the TN coverage reference
  location (e.g., referenceLocationTN) is larger than a
  distance threshold (e.g., rangeTN), the UE may choose not
  to perform measurements of NR inter-frequency cells of
  equal or lower priority, or inter-RAT frequency cells of
  lower priority;
- Else, the UE performs measurements of NR inter-
  frequency cells of equal or lower priority, or inter-RAT
  frequency cells of lower priority according to TS 38.133;
```

```
- Else, the UE may choose not to perform measurements of NR
  inter-frequency cells of equal or lower priority, or inter-RAT
  frequency cells of lower priority;
```

```
- Else, the UE performs measurements of NR inter-frequency cells of equal
  or lower priority, or inter-RAT frequency cells of lower priority
  according to TS 38.133.
```

```
- If the UE supports relaxed measurement and relaxedMeasurement is present in SIB2, the
  UE may further relax the needed measurements, as specified in 3GPP standard
  specification.
```

In another embodiment, if TN coverage information is provided, regardless of the RSRP/RSRQ of the serving cell and/or neighbor cells, when the UE is within TN coverage, the UE starts to measure TN cell(s). For this case, the enhanced measurement is provided: if the TN coverage information (e.g., referenceLocationTN, rangeTN) are broadcasted in SI (e.g., SIB2, and/or SIB3, and/or SIB4, and/or SIB19), the UE performs intra-frequency, inter-frequency or inter-RAT measurements when the distance between the UE and the TN coverage reference location (e.g., referenceLocationTN) is smaller than a distance threshold (e.g., rangeTN), regardless if the serving cell fulfils Srxlev>SIntraSearchP and Squal>SIntraSearchQ, or Srxlev>SnonIntraSearchP and Squal>SnonIntraSearchQ. The exact time to start measurement of TN cell(s) is up to UE implementation. The UE performs measurements of higher priority NR inter-frequency or inter-RAT frequencies according to TS 38.133 regardless of the distance between the UE and the TN coverage reference location (e.g., referenceLocationTN).

In one embodiment, for a NR inter-frequency or inter-RAT frequency with a reselection priority higher than the reselection priority of the current NR frequency, following operations are performed as shown in TABLE 2.

```
TABLE 2
- If TN coverage information (e.g., referenceLocationTN, rangeTN) are not broadcasted in SI
  (e.g., SIB2, and/or SIB3, and/or SIB4, and/or SIB19), the UE may perform measurements
  of higher priority NR inter-frequency or inter-RAT frequencies according to TS 38.133.
- If TN coverage information (e.g., referenceLocationTN, rangeTN) are broadcasted in SI
  (e.g., SIB2, and/or SIB3, and/or SIB4, and/or SIB19),
```

```
- If the distance between UE and the TN coverage reference location (e.g.,
  referenceLocationTN) is larger than a distance threshold (e.g., rangeTN), the UE is
  not required to measure TN cells of higher priority NR inter-frequency or inter-RAT
  frequencies, the UE measures NTN cells of higher priority NR inter-frequency or
  inter-RAT frequencies
- Else, the UE may perform measurements for TN cells of higher priority NR inter-
  frequency or inter-RAT frequencies according to TS 38.133.
```

For one more embodiment, for intra-frequency measurement:
- If the serving cell fulfils Srxlev > S_{IntraSearchP} and Squal > S_{IntraSearchQ}:

- If distanceThresh and referenceLocation are broadcasted in SIB19, and if UE supports
location-based measurement initiation and has obtained its location information:

- If the distance between UE and the serving cell reference location referenceLocation is
shorter than distanceThresh, the UE may not perform intra-frequency measurements;
- Else:

- if TN coverage information (e.g., referenceLocationTN, rangeTN) are broadcasted
in SI (e.g., SIB2, and/or SIB3, and/or SIB4, and/or SIB19):

```
- If the distance between UE and the TN coverage reference location (e.g.,
  referenceLocationTN) is larger than a distance threshold (e.g., rangeTN), the UE
  may not perform intra-frequency measurements for TN cells, and the UE
  performs intra-frequency measurements for NTN cells.
- else the UE performs intra-frequency measurements for only TN cells or for
  any cells (TN, NTN).
```

- else, the UE may perform intra-frequency measurements;

- Else, the UE may not perform intra-frequency measurements;

- Else:

- if TN coverage information (e.g., referenceLocationTN, rangeTN) are broadcasted in SI
(e.g., SIB2, and/or SIB3, and/or SIB4, and/or SIB 19):

```
- If the distance between UE and the TN coverage reference location (e.g.,
  referenceLocationTN) is larger than a distance threshold (e.g., rangeTN), the UE may
  not perform intra-frequency measurements for TN cells, and the UE performs intra-
  frequency measurements for NTN cells.
- else the UE performs intra-frequency measurements for only TN cells or for any cells
  (TN, NTN).
```

- else, the UE may perform intra-frequency measurements

In yet another embodiment, for a NR inter-frequency with an equal or lower reselection priority than the reselection priority of the current NR frequency and for inter-RAT frequency with lower reselection priority than the reselection priority of the current NR frequency, following operations are performed as shown in TABLE 3.

TABLE 3
- If the serving cell fulfils Srxlev > S_{nonIntraSearchP} and Squal > S_{nonIntraSearchQ}:

- If distanceThresh and referenceLocation are broadcasted in SIB 19, and if UE supports
location-based measurement initiation and has obtained its UE location information:

```
- If the distance between UE and the serving cell reference location referenceLocation
  is shorter than distanceThresh, the UE may choose not to perform measurements of
  NR inter-frequency cells of equal or lower priority, or inter-RAT frequency cells of
  lower priority;
- Else,
```

- if TN coverage information (e.g., referenceLocationTN, rangeTN) are
broadcasted in SI (e.g., SIB2, and/or SIB3, and/or SIB4, and/or SIB19):

```
- If the distance between UE and the TN coverage reference location (e.g.,
  referenceLocationTN) is larger than a distance threshold (e.g., rangeTN), the
  UE may not perform measurements of NR inter-frequency TN cells of equal
  or lower priority, or inter-RAT frequency TN cells of lower priority, and the
  UE performs measurements of NR inter-frequency NTN cells of equal or
  lower priority, or inter-RAT frequency NTN cells of lower priority.
- else the UE performs TN and NTN measurements of NR inter-frequency cells
  of equal or lower priority, or inter-RAT frequency cells of lower priority
  according to TS 38.133;
```

```
- else, the UE may perform measurements of NR inter-frequency cells of equal or
  lower priority, or inter-RAT frequency cells of lower priority according to TS
  38.133;
```

- Else, the UE may choose not to perform measurements of NR inter-frequency cells of
equal or lower priority, or inter-RAT frequency cells of lower priority;

- Else,

- if TN coverage information (e.g., referenceLocationTN, rangeTN) are broadcasted in SI
(e.g., SIB2, and/or SIB3, and/or SIB4, and/or SIB 19):

```
- If the distance between UE and the TN coverage reference location (e.g.,
  referenceLocationTN) is larger than a distance threshold (e.g., rangeTN), the UE
  may not perform measurements of NR inter-frequency TN cells of equal or lower
  priority, or inter-RAT frequency TN cells of lower priority, and the UE performs
  measurements of NR inter-frequency NTN cells of equal or lower priority, or inter-
  RAT frequency NTN cells of lower priority.
- else the UE performs TN and NTN measurements of NR inter-frequency cells of
  equal or lower priority, or inter-RAT frequency cells of lower priority according to
  TS 38.133;
```

- else, the UE may perform measurements of NR inter-frequency cells of equal or lower
priority, or inter-RAT frequency cells of lower priority according to TS 38.133;

For a cell selection/reselection operation, a UE usually measures neighbor cell to search for a suitable or acceptable cell to camp on as specified in 3GPP standard specification. The NW can provide configurations on neighbor cell measurement and cell (re)-selection. The configuration can contain cell re-selection information common for intra-frequency, inter-frequency and/or inter-RAT cell re-selection, cell re-selection information per frequency (i.e., information about other NR frequencies and inter-frequency neighbor cells relevant for cell reselection), as well as cell-specific cell re-selection information for intra-frequency, inter-frequency and/or inter-RAT neighbor cells. For a UE in a connected state (e.g., RRC_CONNECTED), the NW can provide measurement configuration for a measurement object (e.g., a TN/NTN neighbor cell).

For a UE supporting NTN, the UE may need to measure both TN neighbor cells and NTN neighbor cells. For NTN neighbor cells, the NW may provide additional assistance information (e.g., ephemeris, epoch time, validity duration, polarization information, common TA parameters, etc.). The signaling of the NTN neighbor cell assistance information and a UE procedure to apply the assistance information are desired to be specified.

The present disclosure includes solutions on how to signal the NTN neighbor cell assistance information, the UE procedure to apply the assistance information, and how a UE supporting NTN distinguishes TN and NTN cells when performing neighbor cell measurement and cell (re)-selection. The embodiments of corresponding UE and NW behaviors are included.

In the preset disclosure, the assistance information for an NTN neighbor measurement and/or NTN cell (re)-selection includes ephemeris and/or epoch time, and/or validity duration and/or polarization information and/or common TA parameters and/or information included in IE ntn-config as specified in 3GPP standard specification and/or service stop time information (t-Service) and/or reference location information (e.g., center coordinates of a cell or a coverage area) and/or any other NTN-specific parameters (i.e., parameters/information applicable only to NTN) and/or NTN cell type indication which indicates the cell is an NTN cell.

In the present disclosure, the assistance information for a TN neighbor measurement and/or TN cell (re)-selection includes TN geographic coverage information (e.g., reference location and/or radius for the cell coverage area) and/or TN cell type indication which indicates the cell is a TN cell.

In the present disclosure, an NTN refers to one or more of satellite, high altitude platform station (HAPS) and air to ground (ATG) scenarios.

In one embodiment, for a UE supporting both TN and NTN, to let the UE perform intra-frequency, inter-frequency and/or inter-RAT frequency TN and NTN neighbor cell measurement on a frequency band that is used for both TN and NTN, the NW can provide cell-specific measurement configuration and/or cell (re)-selection configuration, which can be associated with cell ID (e.g., physical cell ID (PCI)). The NW can also provide a neighboring cell list (e.g., PCI list) which includes both TN and NTN neighbor cells.

For an NTN neighbor cell, the UE can receive the associated assistance information for NTN cell measurement and/or for NTN cell (re)-selection by common signaling or by UE-dedicated signaling. The assistance information can be conveyed by common signaling (e.g., in system information by broadcast, in group-common information by multicast). The assistance information can also be conveyed by UE-dedicated signaling (e.g., in RRC messages including RRCReconfiguration and/or RRCRelease). The UE can determine the neighbor cell is an NTN cell if the associated assistance information for NTN cell measurement and/or for NTN cell (re)-selection are provided. The UE thus performs measurement, and/or measurement reporting, and/or cell (re)-selection based on the procedures/rules specified for NTN.

In one example, for a neighbor cell without the assistance information provided for NTN cell measurement and/or for NTN cell (re)-selection, if cell-specific measurement configuration and/or cell (re)-selection configuration for this cell is provided, the UE determines the cell is a TN cell and the cell-specific measurement configuration and/or cell (re)-selection configuration for this cell are for TN cell measurement and/or for TN cell (re)-selection. The UE thus performs measurement, and/or measurement reporting, and/or cell (re)-selection based on the procedures/rules specified for TN.

In one example, for a neighbor cell without the assistance information provided for NTN cell measurement and/or for NTN cell (re)-selection, if cell-specific measurement configuration and/or cell (re)-selection configuration for this cell is NOT provided, the UE determines the cell is a TN cell, and thus performs measurement, and/or measurement reporting, and/or cell (re)-selection based on the procedures/rules specified for TN; alternatively, the UE determines the cell is an NTN cell, and thus may perform measurement, and/or measurement reporting, and/or cell (re)-selection based on the procedures/rules specified for NTN; alternatively, the UE can consider the cell is either a TN cell or an NTN cell up to UE implementation, and thus may or may not perform measurement, and/or measurement reporting, and/or cell (re)-selection based on the procedures/rules specified for either TN or NTN up to implementation; alternatively, the UE can determine whether the cell is TN or NTN by receiving and decoding the information (e.g., cell barred information, system information scheduling configuration) in MIB and/or SIB1 of the cell, and can perform measurement, and/or measurement reporting, and/or cell (re)-selection based on the corresponding procedures/rules.

In another example, for a TN neighbor cell, the UE can receive the associated assistance information for TN cell measurement and/or for TN cell (re)-selection by common signaling or by UE-dedicated signaling. The assistance information can be conveyed by common signaling (e.g., in system information by broadcast, in group-common information by multicast). The assistance information can also be conveyed by UE-dedicated signaling (e.g., in RRC messages including RRCReconfiguration and/or RRCRelease). The UE can determine the neighbor cell is a TN cell if the associated assistance information for TN cell measurement and/or for TN cell (re)-selection are provided. The UE thus performs measurement, and/or measurement reporting, and/or cell (re)-selection based on the procedures/rules specified for TN.

In another embodiment, for a UE supporting both TN and NTN, to let the UE perform intra-frequency, inter-frequency and/or inter-RAT frequency TN and NTN neighbor cell measurement, the NW can indicate the frequency band number and/or carrier frequency. The UE receives the frequency band number and/or carrier frequency conveyed by common signaling (e.g., in system information by broadcast, in group-common information by multicast) or by UE-dedicated signaling (e.g., in RRC messages including RRCReconfiguration and/or RRCRelease).

If the corresponding frequency number and/or carrier frequency is assigned for TN, the UE determines the neighbor cells on this frequency band are TN cells. The UE thus performs measurement, and/or measurement reporting, and/or cell (re)-selection based on the procedures/rules specified for TN. If the corresponding frequency number and/or carrier frequency is assigned for NTN, the UE determines the neighbor cells on this frequency band are NTN cells. The UE thus performs measurement, and/or measurement reporting, and/or cell (re)-selection based on the procedures/rules specified for NTN.

To signal the assistance information in UE dedicated signaling for NTN neighbor cell measurement, as one example, the assistance information can be included in the measurement object configuration. A measurement object can be configured with a frequency to be measured, where the frequency can be a TN specified frequency, or an NTN specified frequency, or a frequency shared by TN and NTN. Associated to the frequency, a list of one or more NTN neighbor cell IDs (e.g., PCI, logical ID) and/or satellite IDs can be included in the measurement object.

For a frequency/cell/satellite, in one example, the corresponding assistance information can be included in the measurement object configuration in a UE-dedicated message (e.g., in RRC messages); in another example, the corresponding assistance information can be included in a SIB (e.g., SIB19).

To signal the assistance information in cell common signaling (e.g., in SIB) for NTN neighbor cell measurement, as one example, the assistance information can be included in the existing SIBs (e.g., SIB3/4/5) that configure intra-/inter-frequency measurement. For an NTN-accessible frequency, a list of NTN neighbor cell IDs (e.g., PCI, logical ID) and/or satellite IDs can be configured. For a frequency/cell/satellite, in one example, the corresponding assistance information can be included in the same SIB (e.g., SIB3/4/5); in another example, the corresponding assistance information can be included in a separate SIB (e.g., SIB19, a new SIB).

A TN serving cell can provide assistance information for a UE to measure NTN neighbor cells. In one embodiment, SIB19 is utilized to provide the assistance information, where SIB19 only contains the NTN neighbor cell configuration (e.g., NTN-NeighCellConfig). In an NTN, SIB19 contains NTN-specific parameters for serving cell and optionally NTN-specific parameters for neighbor cells, while in TN, SIB19 contains only NTN-specific parameters for neighbor cells. In an NTN, SIB19 is broadcast periodically with NTN-specific parameters for serving cell, or provided by dedicated system information delivery when the UE has an active BWP with no common search space configured. When SIB19 is scheduled in NTN, the si-BroadcastStatus for the mapped SIB19 is set to broadcasting.

In one embodiment, in a TN, SIB19 belongs to Other SI, that can be periodically broadcast on DL-SCH, broadcast on-demand on DL-SCH (i.e., upon request from UEs in RRC_IDLE, RRC_INACTIVE, or RRC_CONNECTED), or sent in a dedicated manner on DL-SCH to UEs in RRC_CONNECTED (i.e., upon request, if configured by the network, from UEs in RRC_CONNECTED or when the UE has an active BWP with no common search space configured or when the UE configured with inter cell beam management is receiving DL-SCH from a TRP with PCI different from serving cell's PCI). When SIB19 is scheduled in TN, the si-BroadcastStatus for the mapped SIB19 is set to either broadcasting or not broadcasting.

In another embodiment, in a TN, SIB19 is broadcast periodically with NTN-specific parameters for serving cell, or provided by dedicated system information delivery when a UE has an active BWP with no common search space configured. When SIB19 is scheduled in TN, the si-BroadcastStatus for the mapped SIB19 is set to broadcasting.

When a UE accessing a cell, the UE first acquires MIB and SIB1 of the cell. A UE capable of NTN acquires SIB1 and/or SIB19 to determine whether the cell is an NTN cell. For instance, a NW can include cell barring indication for NTN (e.g., cellBarredNTN) in SIB1. If the cell barring indication for an NTN is configured in SIB1, the UE determines the cell is an NTN cell; else if the cell barring indication for NTN is not configured in SIB1, the UE determines the cell is a TN cell.

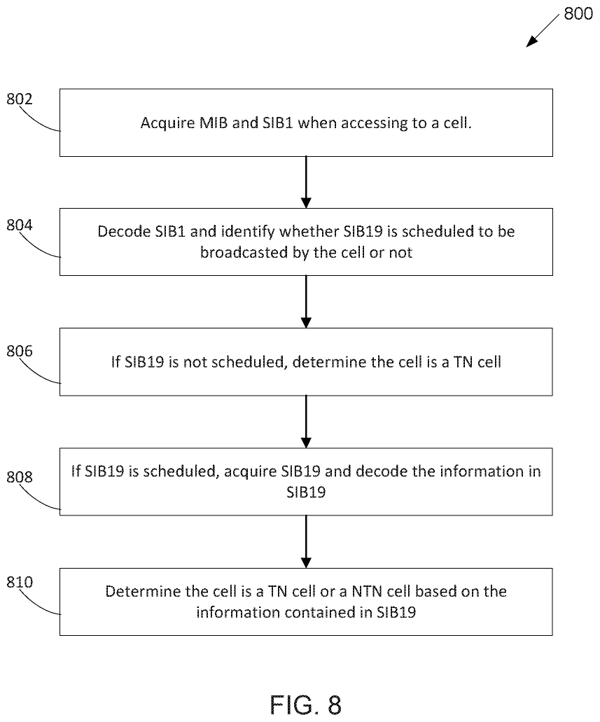

For another instance, if more than one tracking area codes are configured for at least one PLMN-IdentityInfo in SIB1, a UE determines the cell is an NTN cell; else if there is at most one tracking area code for each PLMN-IdentityInfo, the UE determines the cell is a TN cell. As illustrated in FIG. 8, in one example, a UE capable of NTN acquires SIB1 and decodes information in SIB1 to identify whether SIB19 is scheduled to be broadcasted or not. If SIB19 is not scheduled, the UE determines the cell is a TN cell; else if SIB19 is scheduled, the UE acquires SIB19 and decodes information in SIB19. If only NTN neighbor cell configuration is contained in SIB19, the UE determines the cell is a TN cell; else if serving cell information is contained in SIB19 besides the NTN neighbor cell configuration, the UE determines the cell is an NTN cell. Upon receiving SIB19, the UE in RRC_CONNECTED may start or restart T430 for serving cell, if configured, with the timer value set to ntn-UlSync ValidityDuration for the serving cell from the subframe indicated by epochTime for the serving cell.

FIG. 8 illustrates a flowchart of UE procedure 800 for UE-estimated TA in mobility according to embodiments of the present disclosure. The UE procedure 800 as may be performed by a UE (e.g., 111-116 as illustrated in FIG. 1). An embodiment of the UE procedure 800 shown in FIG. 8 is for illustration only. One or more of the components illustrated in FIG. 8 can be implemented in specialized circuitry configured to perform the noted functions or one or more of the components can be implemented by one or more processors executing instructions to perform the noted functions.

As illustrated in FIG. 8, in step 802, a UE acquire MIB and SIB1 when accessing to a cell. In step 804, the UE decodes SIB1 and identify whether SIB19 is scheduled to be broadcasted by the cell or not. In step 806, the UE, if SIB19 is not scheduled, determines whether the cell is a TN cell. In step 808, the UE, if SIB19 is scheduled, acquires SIB19 and decode the information in SIB19. Finally, in step 810, the UE determines whether the cell is a TN cell, or an NTN cell based on the information contained in SIB19.

In one more embodiment, a TN serving cell can broadcast a new SIB containing the intra-/inter-frequency measurement configuration for NTN neighbor cells. The new SIB can specify a list of frequencies similar as SIB3/4/5 and include NTN assistance information for each frequency. The assistance information can be provided per frequency or per satellite or per cell. If the assistance information is provided per satellite or per cell, a list of one or more NTN satellite IDs and/or neighbor cell IDs and the assistance information corresponding to the NTN satellite IDs and/or neighbor cell IDs are provided in the new SIB in association to the one or more frequencies to be measured.

For an NTN neighbor cell measurement operation, a UE receives the assistance information in UE-dedicated signaling (e.g., RRC messages) or in the cell common signaling (e.g., SIB) and measures the NTN frequencies/cells according to the measurement configuration. In one embodiment, if NTN assistance information for a frequency/cell is configured in a measurement object or in a SIB, the UE applies the associated assistance information to measure the frequency/cell. In one embodiment, the validity of the assistance information is controlled by a validity timer and maintained by the UE. If a validity timer (e.g., T430) with timer length and epoch time is configured in the assistance information for an NTN frequency/neighbor cell/satellite, the UE (re)-starts the validity timer from the epoch time and set the timer length.

For instance, the epoch time is indicated by a SFN and a sub-frame number, and the SFN refers to the SFN nearest to the frame where the message indicating the epoch time is received. If the validity timer is expired, in one example, the UE can stop measuring the associated frequency/cell; in a second example, the UE can stop measuring the associated frequency/cell if the assistance information is received in UE-dedicated signaling (e.g., RRC messages); in a third example, the UE can stop measuring the associated frequency/cell and reacquire the SIB containing the assistance information if the assistance information is received in SIB.

In one embodiment, the validity of the assistance information is controlled by a NW. The NW provides valid assistance information in UE-dedicated signaling (e.g., RRC messages) or in the cell common signaling (e.g., SIB). NW updates the assistance information by sending an RRCReconfiguration message or by broadcasting SIB with updated information. A UE follows SI modification procedure to acquire the updated assistance information in SIB, for which the SI change is indicated in system information change notifications or in a modification of valueTag in SIB1.

In one embodiment, a new SIB for NTN is supported to provide TN coverage area information to assist neighbor cell measurements in NTN cells. The new SIB belongs to Other SI, that can be periodically broadcast on DL-SCH, broadcast on-demand on DL-SCH (i.e., upon request from UEs in RRC_IDLE, RRC_INACTIVE, or RRC_CONNECTED), or sent in a dedicated manner on DL-SCH to UEs in RRC_CONNECTED (i.e., upon request, if configured by the network, from UEs in RRC_CONNECTED or when the UE has an active BWP with no common search space configured or when the UE configured with inter cell beam management is receiving DL-SCH from a TRP with PCI different from serving cell's PCI).

When the new SIB is scheduled, the si-BroadcastStatus for the mapped SIB19 is set to either broadcasting or not broadcasting. In one more embodiment, a new SIB for NTN is supported to provide TN coverage area information to assist neighbor cell measurements in NTN cells. The new SIB belongs to Other SI, that is broadcast periodically or provided by dedicated system information delivery when a UE has an active BWP with no common search space configured. When the new SIB is scheduled in NTN, the si-BroadcastStatus for the mapped SIB19 is set to broadcasting.

For conditional handover (CHO) with earth-moving serving cell and/or earth-moving candidate cell(s), to determine the real-time reference coordinates of a reference location in a location-based event (e.g., event D1 condEvent D1), an initial reference location, and/or a list of velocities, and/or a list of reference times can be provided, where the initial reference location is the coordinates at the earliest reference time in the list. For the time interval between two consecutive reference times, the UE can determine the real-time reference location using the reference location coordinates at the earlier reference time and velocity at the earlier reference time.

The reference location coordinates can be indicated using one or more IEs from Ellipsoid-Point, Ellipsoid-PointWithUncertaintyCircle, EllipsoidPointWithUncertaintyEllipse, EllipsoidPointWithAltitude, EllipsoidPoint WithAltitudeAndUncertaintyEllipsoid, and EllipsoidArc specified in 3GPP standard specification TS 37.355. The velocity be indicated using one or more IEs from HorizontalVelocity, HorizontalWithVerticalVelocity, HorizontalVelocity WithUncertainty, and HorizontalWithVerticalVelocityAndUncertainty specified in TS 37.355. The reference time can be indicated in a format of UTC time, where the parameter counts the number of UTC seconds in 10 ms units since 00:00:00 on Gregorian calendar date 1 Jan. 1900 (midnight between Sunday, Dec. 31, 1899, and Monday, Jan. 1, 1900). Alternatively, the reference time can be indicated by the SFN and/or slot number and/or symbol number.

To reduce signaling overhead, the list of velocities can be indicated in a fixed order (e.g., an order in time). For instance, the velocity for a later reference time follows the velocity for an earlier reference time. In another option, for the velocity at a later reference time (e.g., the (n+1)-th velocity in the sequence), the offset to the velocity at an earlier reference time (e.g., the n-th velocity in the sequence) can be indicated. The velocity offset can be indicated in longitude (Y) and/or latitude (X) and/or altitude (Z).

Alternatively, the offset can also be indicated by a distance offset in meters (e.g., using integer parameters, Xoffset, Yoffset, and Zoffset, in the range of a negative integer to an positive integer and a fixed step-size O so that the actual distance offset is expressed as (Xoffset, Yoffset, Zoffset)*O)) and an angle offset ranging from 0° to 359.999 . . . ° or 0.000 . . . 1° to 360° describing a full circle from 0° to 360°. To indicate the reference time, for a later reference time, the time offset to the earlier reference time can be indicated. The time offset can be indicated in seconds and/or milliseconds and/or system frame numbers and/or subframes and/or slots and/or symbols.

For ATG, a new SIB is supported to provide location information for ATG UE to perform TA and frequency pre-compensation. The new SIB can be essential for ATG UE to access NR networks. In one embodiment, the new SIB belongs to Other SI, that is broadcast periodically or provided by dedicated system information delivery when the UE has an active BWP with no common search space configured. When the new SIB is scheduled in NTN, the si-BroadcastStatus for the mapped SIB19 is set to broadcasting.

In another embodiment, the new SIB belongs to Other SI, that can be periodically broadcast on DL-SCH, broadcast on-demand on DL-SCH (i.e., upon request from UEs in RRC_IDLE, RRC_INACTIVE, or RRC_CONNECTED), or sent in a dedicated manner on DL-SCH to UEs in RRC_CONNECTED (i.e., upon request, if configured by the network, from UEs in RRC_CONNECTED or when the UE has an active BWP with no common search space configured or when the UE configured with inter cell beam management is receiving DL-SCH from a TRP with PCI different from serving cell's PCI). When the new SIB is scheduled, the si-BroadcastStatus for the mapped SIB19 is set to either broadcasting or not broadcasting.

An RRC connection release procedure is supported, as specified in 3GPP standard specification to release the RRC connection, which includes the release of the established radio bearers (except for broadcast MRBs), BH RLC channels, Uu relay RLC channels, PC5 relay RLC channels as well as all radio resources; or to suspend the RRC connection only if SRB2 and at least one DRB or multicast MRB or, for IAB, SRB2, are setup, which includes the suspension of the established radio bearers (except for broadcast MRBs).

A network initiates the RRC connection release procedure by sending an RRCRelease message to transit a UE in RRC_CONNECTED to RRC_IDLE; or to transit a UE in RRC_CONNECTED to RRC_INACTIVE only if SRB2 and at least one DRB or multicast MRB or, for IAB, SRB2, is setup in RRC_CONNECTED; or to transit a UE in RRC_INACTIVE back to RRC_INACTIVE when the UE tries to resume (for resuming a suspended RRC connection or for initiating SDT); or to transit a UE in RRC_INACTIVE to RRC_IDLE when the UE tries to resume (for resuming of a suspended RRC connection or for initiating SDT). The procedure can also be used to release and redirect a UE to another frequency.

For a UE connecting to an NTN cell, the UE delays the RRC connection release actions by a longer timer (denoted X ms) from the reception of RRCRelease to wait for successful acknowledgement of the reception of RRCRelease, where X ms takes into account the maximum round trip time (RTT) between UE and an NTN cell (e.g., 545 ms for GEO). In one example, X can be 60 ms plus a UE-gNB RTT or 610 ms or 1.25 seconds or 10 seconds.

When receiving the RRCRelease message, the UE may: (1) except for NTN access (e.g., UE connecting to an NTN cell), delay the actions for RRC connection release 60 ms from the moment the RRCRelease message was received or optionally when lower layers indicate that the receipt of the RRCRelease message has been successfully acknowledged, whichever is earlier; and/or (2) for NTN access (e.g., UE connecting to an NTN cell), delay the actions for RRC connection release 610 ms or 1.25 seconds or 10 seconds from the moment the RRCRelease message was received or optionally when lower layers indicate that the receipt of the RRCRelease message has been successfully acknowledged, whichever is earlier.

For an NTN access (e.g., UE connecting to an NTN cell), when a UE has sent positive HARQ feedback (ACK), the lower layers can be considered to have indicated that the receipt of the RRCRelease message has been successfully acknowledged.

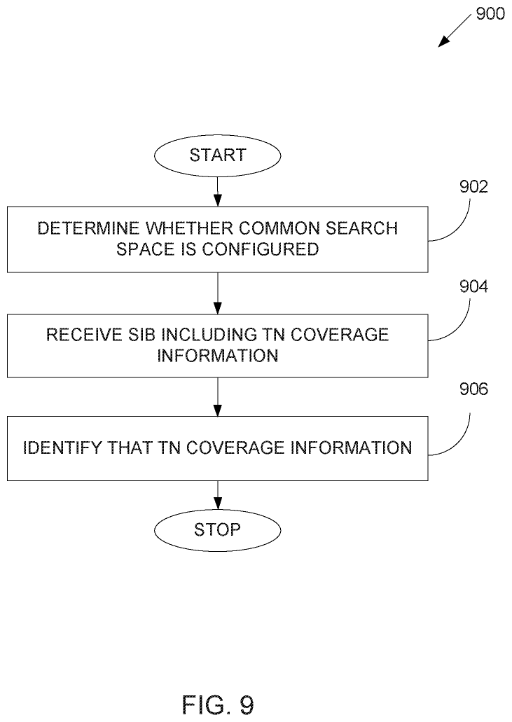

FIG. 9 illustrates a flowchart of UE method 900 for an NTN neighbor cell measurement operation according to embodiments of the present disclosure. The UE method 900 as may be performed by a UE (e.g., 111-116 as illustrated in FIG. 1). An embodiment of the UE method 900 shown in FIG. 9 is for illustration only. One or more of the components illustrated in FIG. 9 can be implemented in specialized circuitry configured to perform the noted functions or one or more of the components can be implemented by one or more processors executing instructions to perform the noted functions.

As illustrated in FIG. 9, the method 900 begins at step 902. In step 902, a UE determines whether a common search space is configured for an active BWP.

In step 904, the UE receives from a BS via a dedicated system information, a first SIB including TN coverage information based on a determination that the common search space is not configured for the active BWP.

In step 906, The UE identifies that the TN coverage information belongs to Other SI.

In one embodiment, when the UE is connected to a TN, the UE receives a second SIB via a periodic broadcast signaling, a broadcast on-demand signaling, or a dedicated signaling, wherein the second SIB comprises an SIB19 that includes NTN-specific parameters for NTN neighbor cells, and wherein the SIB19 belongs to the other SI.

In one embodiment, when the UE is connected to an ATG network, the UE receives a second SIB including location information for an ATG network access via a periodic broadcasting signaling, a broadcast on-demand signaling, or a dedicated signaling, wherein the second SIB belongs to the other SI.

In one embodiment, the UE receives, from a source cell, broadcast configuration including addition, modification, or release list of one or more HO target cells, and adds, modifies, or releases target cells for a HO operation based on the broadcast configuration.

In one embodiment, the UE maintains a variable by adding, modifying, or releasing the target cells based on the broadcast configuration for the HO operation.

In one embodiment, the UE receives a HO command or a CHO command to identify a target cell based on the variable.

In one embodiment, the UE executes a HO operation to the target cell and applies the broadcast configuration and a configuration included in the HO command or the CHO command.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a processor configured to determine whether a common search space is configured for an active bandwidth part (BWP); and
a transceiver operably coupled to the processor, the transceiver configured to receive, from a base station (BS) via a dedicated system information, a first system information block (SIB) including terrestrial network (TN) coverage information based on a determination that the common search space is not configured for the active BWP,
wherein the processor is further configured to identify that the TN coverage information belongs to other system information (SI).

2. The UE of claim 1, wherein, when the UE is connected to a TN:
the transceiver is further configured to receive a second SIB via a periodic broadcast signaling, a broadcast on-demand signaling, or a dedicated signaling;
the second SIB comprises an SIB19 that includes NTN-specific parameters for NTN neighbor cells; and
the SIB19 belongs to the other SI.

3. The UE of claim 1, wherein, when the UE is connected to an air to ground (ATG) network:
the transceiver is further configured to receive a second SIB including location information for an ATG network access via a periodic broadcasting signaling, a broadcast on-demand signaling, or a dedicated signaling; and
the second SIB belongs to the other SI.

4. The UE of claim 1, wherein:
the transceiver is further configured to receive, from a source cell, a broadcast configuration including addition, modification, or release list of one or more handover (HO) target cells; and
the processor is further configured to add, modify, or release target cells for a HO operation based on the broadcast configuration.

5. The UE of claim 4, wherein the processor is further configured to maintain a variable by adding, modifying, or releasing the target cells based on the broadcast configuration for the HO operation.

6. The UE of claim 5, wherein the transceiver is further configured to receive a HO command or a conditional handover (CHO) command to identify a target cell based on the variable.

7. The UE of claim 6, wherein the processor is further configured to:
execute a HO operation to the target cell; and
apply the broadcast configuration and a configuration included in the HO command or the CHO command.

8. A method of a user equipment (UE) in a wireless communication system, the method comprising:
determining whether a common search space is configured for an active bandwidth part (BWP);
receiving, from a base station (BS) via a dedicated system information, a first system information block (SIB) including terrestrial network (TN) coverage information based on a determination that the common search space is not configured for the active BWP; and
identifying that the TN coverage information belongs to other system information (SI).

9. The method of claim 8, further comprising, when the UE is connected to a TN, receiving a second SIB via a periodic broadcast signaling, a broadcast on-demand signaling, or a dedicated signaling, wherein the second SIB comprises an SIB19 that includes NTN-specific parameters for NTN neighbor cells, and wherein the SIB19 belongs to the other SI.

10. The method of claim 8, further comprising, when the UE is connected to an air to ground (ATG) network receiving a second SIB including location information for an ATG network access via a periodic broadcasting signaling, a broadcast on-demand signaling, or a dedicated signaling, wherein the second SIB belongs to the other SI.

11. The method of claim 8, further comprising:
receiving, from a source cell, a broadcast configuration including addition, modification, or release list of one or more handover (HO) target cells; and
adding, modifying, or releasing target cells for a HO operation based on the broadcast configuration.

12. The method of claim 11, further comprising maintaining a variable by adding, modifying, or releasing the target cells based on the broadcast configuration for the HO operation.

13. The method of claim 12, further comprising receiving a HO command or a conditional handover (CHO) command to identify a target cell based on the variable.

14. The method of claim 13, further comprising:
executing a HO operation to the target cell; and
applying the broadcast configuration and a configuration included in the HO command or the CHO command.

15. A base station (BS) in a wireless communication system, the BS comprising:
a processor configured to generate a first system information block (SIB) including terrestrial network (TN) coverage information; and
a transceiver operably coupled to the processor, the transceiver configured to transmit, to a user equipment (UE) via a dedicated system information, the first SIB including the TN coverage information, wherein a common search space is not configured for an active bandwidth part (BWP), and wherein the TN coverage information belongs to other system information (SI).

16. The BS of claim 15, wherein, when the UE is connected to a TN:
the transceiver is further configured to transmit a second SIB via a periodic broadcast signaling, a broadcast on-demand signaling, or a dedicated signaling;
the second SIB comprises an SIB19 that includes NTN-specific parameters for NTN neighbor cells; and
the SIB19 belongs to the other SI.

17. The BS of claim 15, wherein, when the UE is connected to an air to ground (ATG) network:
the transceiver is further configured to transmit a second SIB including location information for an ATG network access via a periodic broadcasting signaling, a broadcast on-demand signaling, or a dedicated signaling; and
the second SIB belongs to the other SI.

18. The BS of claim 15, wherein the transceiver is further configured to transmit, to the UE, a broadcast configuration including addition, modification, or release list of one or more handover (HO) target cells.

19. The BS of claim 18, wherein a variable is maintained by adding, modifying, or releasing the target cells based on the broadcast configuration for a HO operation.

20. The BS of claim 19, wherein the transceiver is further configured to transmit a HO command or a conditional handover (CHO) command to identify a target cell based on the variable.
